(19) United States
(12) Patent Application Publication
(10) Pub. No.: US 2014/0062905 A1
(43) Pub. Date: Mar. 6, 2014

(54) TOUCH PANEL

(71) Applicant: SAMSUNG ELECTRO-MECHANICS CO., LTD., Gyunggi-do (KR)

(72) Inventors: Wan Jae Lee, Gyunggi-do (KR); Youn Soo Kim, Gyunggi-do (KR)

(73) Assignee: SAMSUNG ELECTRO-MECHANICS CO., LTD., Gyunggi-do (KR)

(21) Appl. No.: 13/681,944

(22) Filed: Nov. 20, 2012

(30) Foreign Application Priority Data
Sep. 3, 2012 (KR) 10-2012-0097332

(51) Int. Cl. G06F 3/0488

(52) U.S. Cl. CPC G06F 3/0488
USPC 345/173

(57) ABSTRACT

Disclosed herein is a touch panel, including: a window; a transparent substrate having electrode patterns and electrode wirings formed thereon, the electrode wirings being connected to the electrode patterns; a sealing part formed along an edge of one surface of the window and an edge of one surface of the transparent substrate; and a first adhesive layer attaching one surface of the window and one surface of the transparent substrate to each other, the first adhesive layer being surrounded by the sealing part.

### CROSS REFERENCE TO RELATED APPLICATION

This application claims the benefit of Korean Patent Application No. 10-2012-0097332, filed on Sep. 3, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

With the development of computers using digital technology, devices assisting the computers have also been developed, and personal computers, portable transmitters and other personal information processors execute processing of text and graphics using a variety of input devices such as a keyboard, a mouse and so on.

While the rapid advancement of an information-oriented society has been widening the use of computers more and more, it is difficult to efficiently operate products using only a keyboard and mouse currently serving as an input device. Therefore, the need for a device that is simple, has minimum malfunction, and is capable of easily inputting information has increased.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element, or the like, or a cathode ray tube (CRT), so that a user selects desired information while viewing the image display device.

Also, the touch panel is classified into a resistive type, a capacitive type, an electromagnetic type, a surface acoustic wave (SAW) type, and an infrared type. These various types of touch panels are adapted for electronic products in consideration of signal amplification problems, resolution difference, level of difficulty of designing and processing technologies, optical characteristics, electrical characteristics, mechanical characteristics, environment-resistant characteristics, input characteristics, durability, and economic efficiency. Currently, a capacitive type touch panel and a digital resistive type touch panel have been used in a wide range of fields.

Meanwhile, the touch panel according to the related art, as disclosed in the patent document of the related art document below, includes transparent electrodes recognizing a touch coordinate and electrode wirings connected to the transparent electrodes. Here, a bezel part is formed at a glass provided at the outermost region to thereby prevent the electrode wirings from being recognized from the outside. Due to the step height of the bezel part, bubbles are generated when the glass provided at the outermost region and the transparent substrate having transparent electrodes are attached to each other. Even though the generated bubbles are removed by autoclave, the bubbles cannot be easily removed due to the step height of the bezel part. Moreover, an adhesive layer needs to have a large thickness in order to offset the step height of the bezel part, and in this case, the light transmittance may be decreased.

### RELATED ART DOCUMENT

### Patent Document

### (Patent Document 1) US20110298728 A1

### SUMMARY OF THE INVENTION

The present invention has been made in an effort to provide a touch panel capable of, by surrounding an adhesive layer attaching a window and a transparent substrate with a sealing part, omitting an adhesive layer at a region corresponding to a bezel part.

According to a preferred embodiment of the present invention, there is provided a touch panel, including: a window; a transparent substrate having electrode patterns and electrode wirings formed thereon, the electrode wirings being connected to the electrode patterns; a sealing part formed along an edge of one surface of the window and an edge of one surface of the transparent substrate; and a first adhesive layer attaching one surface of the window and one surface of the transparent substrate to each other, the first adhesive layer being surrounded by the sealing part.

The sealing part may be extended to a lateral surface of the window.

The sealing part may be extended to the other surface of the transparent substrate.

Here, a portion of the sealing part, which is formed on the other surface of the transparent substrate, may become thinner toward the edge of the transparent substrate.

The touch panel may further include a bezel part formed on one surface of the window.

The bezel part may be protruded from the window.

Here, a portion of one surface of the window, on which the bezel part is formed, may be dented.

The sealing part may be formed to correspond to the bezel part.

The first adhesive layer may be an optical clear adhesive (OCA).

The sealing part may be formed of UV curable resin, thermosetting resin, or Loctite.

The touch panel may further include an anti-reflection (AR) film, a low-reflection (LR) film, or a display, which is provided in a direction of the other surface of the transparent substrate.

The electrode patterns may be formed of copper (Cu), aluminum (Al), gold (Au), silver (Ag), titanium (Ti), palladium (Pd), chrome (Cr), or a combination thereof.

The electrode patterns may be formed of metallic silver formed by exposing/developing a silver salt emulsion layer.

The electrode patterns may be black oxide treated.

### BRIEF DESCRIPTION OF THE DRAWINGS

The above and other objects, features and advantages of the present invention will be more clearly understood from the following detailed description taken in conjunction with the accompanying drawings, in which:

FIGS. 1 to 5 are cross-sectional views of touch panels according to preferred embodiments of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

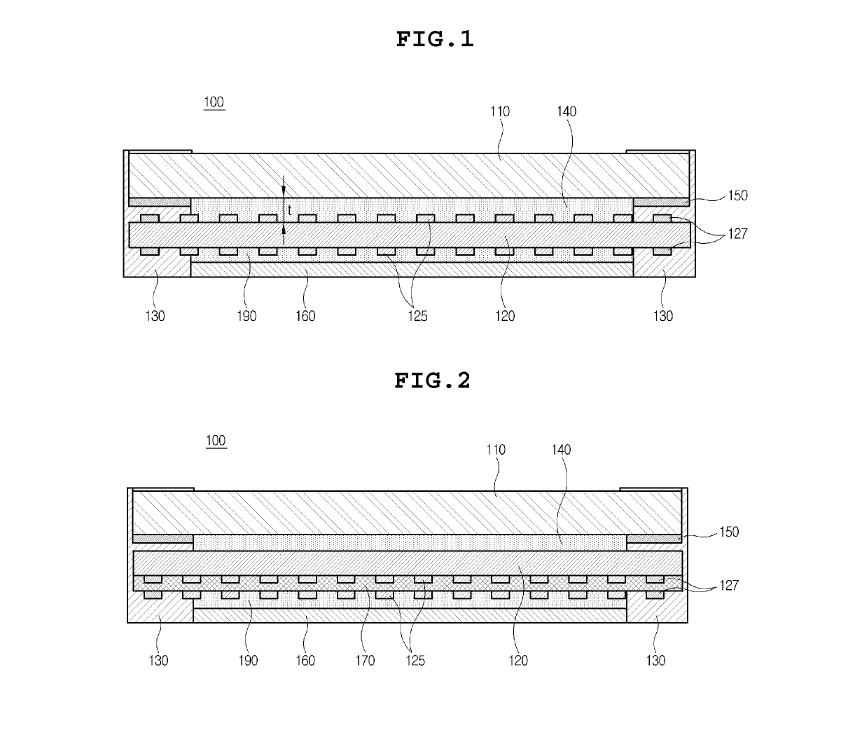

FIGS. 1 to 5 are cross-sectional views of touch panels according to preferred embodiments of the present invention.

As shown in FIGS. 1 to 5, a touch panel 100 according to the present preferred embodiment may include a window 110; a transparent substrate 120 having electrode pattern 125 and electrode wirings 127 connected to the electrode patterns 125, formed on the transparent substrate 120; a sealing part 130 formed along an edge of one surface of the window 110 and an edge of one surface of the transparent substrate 120; and a first adhesive layer 140 attaching one surface of the window 110 and one surface of the transparent substrate 120 to each other, the adhesive layer 140 being surrounded by the sealing part 130.

The window 110 is provided at the outermost side of the touch panel to receive touch of a user. In addition, the window 110 has transparency for allowing the user to recognize an image provided by a display. Here, the window 110 may be formed of glass, reinforced glass, or the like, but is necessarily limited thereto.

The transparent substrate 120 serves to offer an area in which the electrode patterns 125 and the electrode wirings 127 are to be formed. Here, the transparent substrate 120 needs to have a support force for supporting the electrode patterns 125 and the electrode wirings 127 and transparency for allowing a user to recognize an image provided by an image display device. Considering the above-described support force and transparency, the transparent substrate 120 may be formed of polyethyleneterephthalate (PET), polycarbonate (PC), polymethylmethacrylate (PMMA), polyethylenenaphthalate (PEN), polyethersulfone (PES), cyclic olefin copolymer (COC), a triacetylcellulose (TAC) film, a polyvinyl alcohol (PVA) film, a polyimide (PI) film, polystyrene (PS), biaxially oriented polystyrene (BOPS; containing K resin), glass, reinforced glass, or the like, but is not necessarily limited thereto.

In addition, the electrode pattern formed on the transparent substrate 120 generates a signal when being touched by a user, thereby allowing a controller to recognize a touch coordinate. Here, the electrode patterns 125 may be formed in a mesh pattern, by using copper (Cu), aluminum (Al), gold (Au), silver (Ag), titanium (Ti), palladium (Pd), chrome (Cr), or a combination thereof. Here, the electrode pattern 125 may be formed by a depositing process using a plating process or a sputter. In addition, in the case where the electrode pattern 125 is formed of copper (Cu), surfaces of the electrode patterns may be black oxide treated. As such, the surfaces of the electrode patterns 125 are black oxide treated, thereby preventing a light from being reflected, and thus improving visibility of the touch panel 100. Meanwhile, the electrode patterns 125 may be formed of the above foregoing metals, or may be formed by using metal oxide, such as metallic silver obtained by exposing/developing a silver salt emulsion layer or indium thin oxide (ITO), or a conductive polymer, such as PEDOT/PSSS, exhibiting excellent flexibility and a simple coating process. Meanwhile, the electrode patterns 125 may be formed to have every pattern known in the art, such as, a planar rod-shaped pattern, a diamond-shaped pattern, a quadrangular pattern, a triangular pattern, a circular pattern, or the like.

In addition, the electrode wirings 127 are connected to the electrode patterns 125 to serve to receive/transmit an electric signal from/to the electrode patterns 125. Here, the electrode wirings 127 are formed integrally with the electrode patterns 125, thereby simplifying the manufacturing process and shortening the lead time.

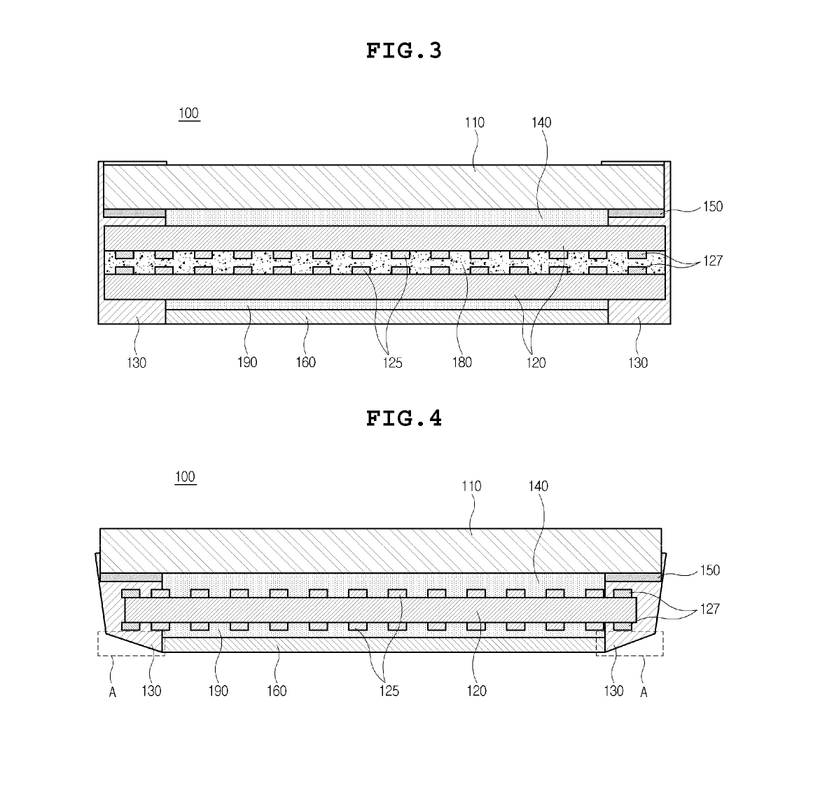

Meanwhile, the transparent substrate 120, the electrode patterns 125, and the electrode wirings 127 may be formed in various configurations. For example, as shown in FIG. 1, the electrode patterns 125 and the electrode wirings 127 may be formed on both surfaces of a single transparent substrate 120. Alternatively, as shown in FIG. 2, after the electrode patterns 125 and the electrode wirings 127 are formed on the transparent substrate 120, an insulating layer 170 is formed on the transparent substrate 120, and then again, electrode patterns 125 and electrode wirings 127 are formed on the insulating layer 170. Alternatively, as shown in FIG. 3, after electrode patterns 125 and electrode wirings 127 are formed on two transparent substrates 120, respectively, the two transparent substrates 120 may be attached to each other with a second adhesive layer 180. The constitution of the touch panel 100 shown in each of FIGS. 1 to 3 is shown based on a capacitive type touch panel, but the touch panel 100 according to the present invention is not limited to the capacitive type touch panel, but may have all types such as a resistive type and the like, known to the art.

The sealing part 130 is formed along the edge of one surface of the window 110 and the edge of one surface of the transparent substrate 120, to surround and thus seal the first adhesive layer 140. Here, the bezel part 150 may be formed on the edge of one surface of the window 110 while covering the electrode patterns 127 or displaying the logo or the like, and the sealing part 130 may be formed to corresponding to the bezel part 150. When the sealing part 130 is formed correspondingly to the bezel part 150 as such, the sealing part 130 is provided at a region of the window 110, in which the bezel part 150 is formed, and the first adhesive layer 140 is provided at a region of the window 110, in which the bezel part 150 is not formed, so that the first adhesive layer 140 at a region corresponding to the bezel part 150 can be omitted in the present invention, unlike the touch panel according to the related art. Therefore, the first adhesive layer 140 does not need to be extended to the region corresponding to the bezel part 150, thereby greatly preventing bubbles from being generated due to the step height of the bezel part 150 which protrudes from the window 110. Even though the bubbles are generated, the generated bubbles can be easily removed by attaching the window 110 and the transparent substrate 120 to each other with the first adhesive layer 140, removing the bubbles, and then forming the sealing part 130 at the region corresponding to the bezel part 150. Also, the first adhesive layer 140 at the region corresponding to the bezel part 150 can be omitted, thereby saving manufacturing cost. In addition, since the first adhesive layer 140 does not need to offset the step height of the bezel part 150, the first adhesive layer 140 can have a thin thickness t (see, FIG. 1), whereby the light transmittance of the touch panel 100 can be increased.

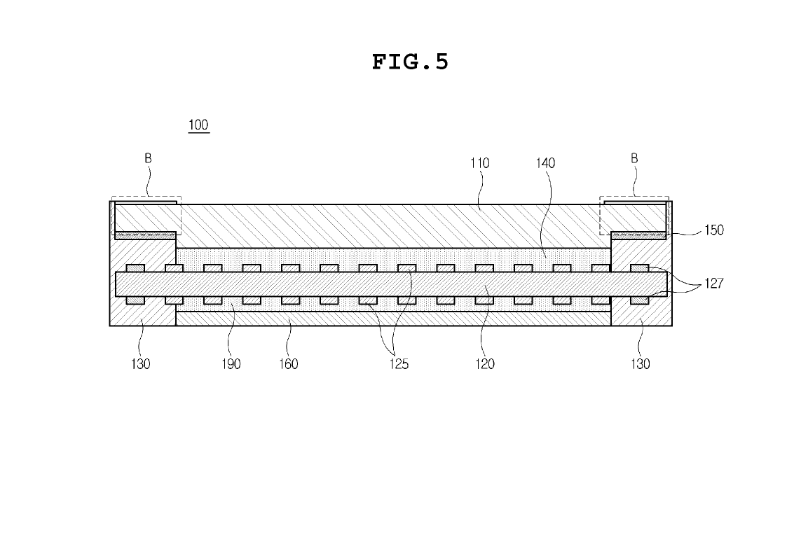

Meanwhile, as shown in FIG. 1, the sealing part 130 may be extended to a lateral surface of the window 110, and extended to the other surface of the transparent substrate 120 via the lateral surface of the transparent substrate 120. As described above, the sealing part 130 is extended to the lateral surface of the window 110 and the other surface of the transparent substrate 120, thereby effectively preventing moisture or vapor from infiltrating into the touch panel 100 later. In addition, as shown in FIG. 4, a portion A of the sealing part 130, which is formed on the other surface of the transparent substrate 120, becomes thinner toward the edge of the transparent substrate 120, thereby maximizing space utilization. Further, as shown in FIG. 5, a portion B of one surface of the window 110, on which the bezel part 150 is formed, may be dented. When the forming region of the bezel part 150 is dented as described above, an interval between the bezel part 150 and the transparent substrate 120 is increased, thereby sufficiently securing a space for forming the sealing part 130 therein.

In addition, the sealing part 130 may be formed of UV curable resin, thermosetting resin, or Loctite, in order to perform effective sealing, but is necessarily limited thereto.

The first adhesive layer 140 serves to attach one surface of the window 110 and one surface of the transparent substrate 120, and is surrounded by the sealing part 130. Here, a material for the first adhesive layer 140 is, but not particularly limited to, an optical clear adhesive (OCA). Here, since the first adhesive layer 140 is surrounded by the sealing part 130, the first adhesive layer 140 does not need to offset the step height of the bezel part 150 as described above, and thus can have a thin thickness t (see, FIG. 1). If the step height of the bezel part 150 needs to be offset, the first adhesive layer 140 needs to have a thickness of 100 μm. However, in the touch panel 100 according to the present preferred embodiment, the step height of the bezel part 150 does not need to be offset by adopting the sealing part 130, whereby the thickness t of the first adhesive layer 140 may be for example 25 μm or smaller.

In addition, a separate substrate 160 may be provided in a direction of the other surface of the transparent substrate 120. Here, the substrate 160 may be an anti-reflection film (AR) film or a low-reflection (LR) film. The AR film serves to prevent reflection of the light, and the LR film serves to reduce reflection of the light. However, the substrate 160 is not necessarily the AR film or the LR film, but a display for providing an image. Here, the substrate 160 may be attached to the transparent substrate 120 (see, FIG. 1) or an insulating layer 170 (see, FIG. 2) by using a third adhesive layer 190. Meanwhile, the sealing part 130 may be extended to coat up to a lateral surface of the substrate 160, thereby entirely sealing the touch panel 100.

As set forth above, according to the present invention, the adhesive layer attaching the window and the transparent substrate to each other is surrounded by a sealing part, so that the adhesive layer at the region corresponding to the bezel part can be omitted, and thus the bubbles generated due to the step height of the bezel part can be easily removed.

Further, according to the present invention, the adhesive layer at the region corresponding to the bezel part is omitted to thereby decrease the area of the adhesive layer, so that the manufacturing cost can be reduced.

Further, according to the present invention, the adhesive layer at the region corresponding to the bezel part is omitted, so that the step height of the bezel part does not need to be offset, and thus, a small thickness adhesive layer can be used, whereby the light transmittance of the touch panel can be increased.

The optical clear adhesive (OCA) is provided in the region requiring transparency, and the sealing part is provided in the region requiring adhesive strength, so that characteristics suitable for each region can be realized.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a window;
a transparent substrate having electrode patterns and electrode wirings formed thereon, the electrode wirings being connected to the electrode patterns;
a sealing part formed along an edge of one surface of the window and an edge of one surface of the transparent substrate; and
a first adhesive layer attaching one surface of the window and one surface of the transparent substrate to each other, the first adhesive layer being surrounded by the sealing part.

2. The touch panel as set forth in claim 1, wherein the sealing part is extended to a lateral surface of the window.

3. The touch panel as set forth in claim 1, wherein the sealing part is extended to the other surface of the transparent substrate.

4. The touch panel as set forth in claim 3, wherein a portion of the sealing part, which is formed on the other surface of the transparent substrate, becomes thinner toward the edge of the transparent substrate.

5. The touch panel as set forth in claim 1, further comprising a bezel part formed on one surface of the window.

6. The touch panel as set forth in claim 5, wherein the bezel part is protruded from the window.

7. The touch panel as set forth in claim 5, wherein a portion of one surface of the window, on which the bezel part is formed, is dented.

8. The touch panel as set forth in claim 5, wherein the sealing part is formed to correspond to the bezel part.

9. The touch panel as set forth in claim 1, wherein the first adhesive layer is an optical clear adhesive (OCA).

10. The touch panel as set forth in claim 1, wherein the sealing part is formed of UV curable resin, thermosetting resin, or Loctite.

11. The touch panel as set forth in claim 1, further comprising an anti-reflection (AR) film, a low-reflection (LR) film, or a display, which is provided in a direction of the other surface of the transparent substrate.

12. The touch panel as set forth in claim 1, wherein the electrode patterns are formed of copper (Cu), aluminum (Al), gold (Au), silver (Ag), titanium (Ti), palladium (Pd), chrome (Cr), or a combination thereof.

13. The touch panel as set forth in claim 1, wherein the electrode patterns are formed of metallic silver formed by exposing/developing a silver salt emulsion layer.

14. The touch panel as set forth in claim 1, wherein the electrode patterns are black oxide treated.
